(19) United States
(12) Patent Application Publication
(10) Pub. No.: US 2009/0097103 A1
(43) Pub. Date: Apr. 16, 2009

(54) Camera Lens and Related Image Reception Device Capable of Filtering Infrared Light and Reducing Production Cost

(76) Inventors: Yung-Chieh Tseng, Taichung City (TW); Kuo-Shu Hung, Taichung County (TW); Wei-Chung Chao, Hsinchu City (TW); Chih-Kuang Huang, Kaohsiung City (TW); Cheng-Feng Huang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/953,825

(22) Filed: Dec. 10, 2007

(30) Foreign Application Priority Data
Oct. 16, 2007 (TW) 096138672

(51) Int. Cl. G02B 13/14

(52) U.S. Cl. 359/356; 359/642

(57) ABSTRACT

In order to prevent infrared from reducing image quality of an image reception device, the present invention discloses a camera lens capable of filtering infrared light. The camera lens includes a barrel, an aperture installed on the barrel for controlling the amount of input light, and an optical lens installed inside the barrel for filtering infrared and performing optical lens.

### BACKGROUND OF THE INVENTION

1. Field of the Invention

The present invention is related to a camera lens and related image reception device capable of filtering infrared light and reducing production cost, more particularly, to a camera lens and related image reception device for filtering infrared light and further simplifying fabrication process through one or several camera lenses capable of filtering infrared light and performing optical lensing.

2. Description of the Prior Art

With advancement of optics technology, image reception devices are more and more popular. Beside digital cameras, mobile devices such as mobile phones, personal digital assistants, and notebooks also have image reception functions installed. In that situation, users will have higher demands for imaging quality of image reception devices.

In the image reception devices, key points of affecting optical lens quality are results of filtering infrared light. The main reason is the transmissivity of infrared light is lower than the transmissivity of visible light. Therefore, in order to avoid affecting imaging quality because of infrared light, an infrared rays filtering element or a sheet glass capable of receiving infrared light is usually added in the prior art image reception device.

Please refer to FIG. 1. FIG. 1 is a schematic diagram of a prior art image reception device 10. The image reception device 10 comprises a barrel 102, an aperture 104, a camera lens assembly 106, an infrared rays filtering element 108, and an image sensor 109. The aperture 104 is utilized for controlling the amount of input light reflected of an object. The camera lens assembly 106 is utilized for performing optical lensing for imaging the object on the image sensor 109. The infrared rays filtering element 108 is installed between the camera lens assembly 106 and the image sensor 109 for filtering infrared rays to avoid affecting imaging quality because of infrared light. The image sensor 109 is utilized for transforming the receiving light into current signals.

Through the infrared rays filtering element 108, the image reception device 10 can filter out infrared rays to improve imaging quality. However, adding an infrared rays filtering element 108 will increase fabrication complexity and production cost. Therefore, how to lower the fabrication complexity and production cost of the prior art image reception device and maintain the imaging quality becomes the quite important topic of the present field.

### SUMMARY OF THE INVENTION

It is therefore a primary objective of the claimed invention to provide a camera lens and related image reception device capable of filtering infrared rays and reducing production cost.

The present invention discloses a camera lens capable of filtering infrared light and comprising a barrel, an aperture installed on the barrel for controlling the amount of input light, and an optical lens installed inside the barrel for filtering the infrared light and performing optical lensing of an object.

The present invention further discloses a camera lens capable of filtering infrared light and comprising a barrel, an aperture installed on the barrel for controlling the amount of input light, and a plurality of optical lenses installed inside the barrel for filtering infrared light and performing optical lensing of an object.

The present invention further discloses an image acquisition gateway capable of reducing production cost and comprising a housing having a front opening; a camera lens comprising a barrel installed on the front opening; an aperture installed on the barrel for controlling the amount of input light; and an optical lens assembly installed inside the barrel for filtering infrared light and performing optical lensing of an object. On the other hand, the image sensor is installed in a location corresponding to the camera lens inside the housing for transforming the input light through the camera lens into current signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art image reception device.

FIG. 2 illustrates a schematic diagram of a camera lens with a single lens according to an embodiment of the present invention.

FIG. 3 illustrates a schematic diagram of an imaging principle of a camera lens with the single lens shown in FIG. 2.

FIG. 4 illustrates a schematic diagram of an imaging principle of a camera lens with the single lens shown in FIG. 2.

FIG. 5 illustrates a schematic diagram of a camera lens with multiple lenses according to an embodiment of the present invention.

FIG. 6 and FIG. 7 illustrate schematic diagrams of an imaging principle of a camera lens with multiple lenses comprising two optical lenses.

FIG. 8 and FIG. 9 illustrate schematic diagrams of an imaging principle of a camera lens with multiple lenses comprising three optical lenses.

FIG. 10 illustrate a schematic diagram of an imaging principle of a camera lens with multiple lenses comprising four optical lenses.

FIG. 11 and FIG. 12 illustrate schematic diagrams of a camera lens with multiple lenses shown in FIG. 5 when realizing zoom lenses.

FIG. 13 illustrates a schematic diagram of an image acquisition gateway according to an embodiment of the present invention.

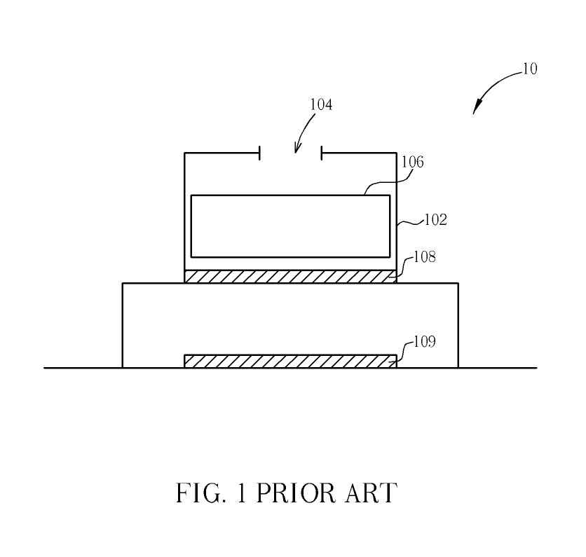

### DETAILED DESCRIPTION

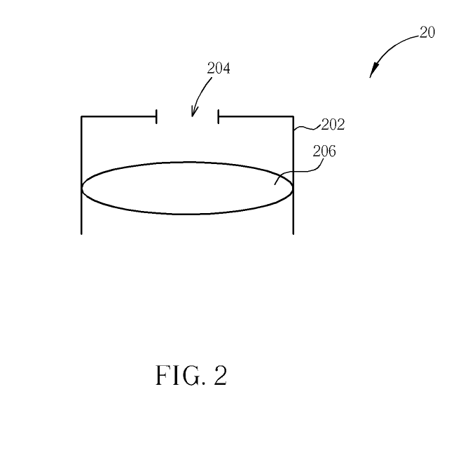

Please refer to FIG. 2. FIG. 2 illustrates a schematic diagram of a camera lens 20 with a single lens of the present invention. The camera lens 20 with a single lens comprises a barrel 202, an aperture 204, and an optical lens 206. The barrel 202 is utilized for protecting the optical lens 206 from damage or accumulating dust. The aperture 204 is utilized for adjusting and controlling the amount of light input into the barrel. The optical lens 206 made by the material capable of filtering infrared light is utilized for filtering infrared light and performing optical lens.

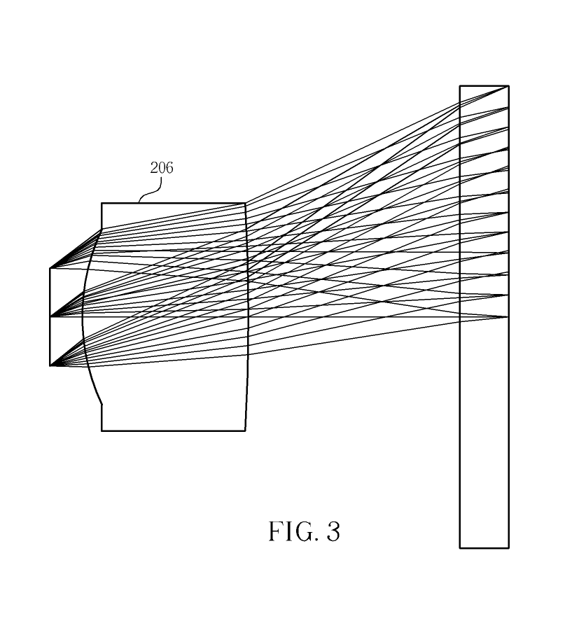

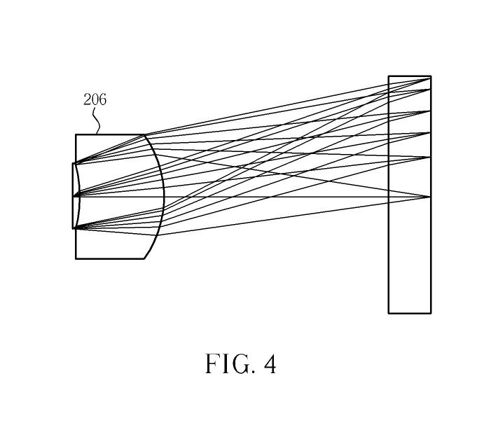

Therefore, the optical lens 206 can filter out the infrared light and image the object on an image sensor or a negative of a photo (not shown on FIG. 2) by the camera lens 20 with a single lens after light transmits into the barrel 202 through the aperture 204. The image principles can be referred to in FIG. 3 (bi-convex lens) and FIG. 4 (concavo-convex lens). In other words, the camera lens 20 with a single lens without extra infrared rays filtering elements or sheet glass can filter the infrared light.

Note that, FIG. 2 illustrates a schematic diagram of a camera lens 20 with single lens according to an embodiment of the present invention. Those skilled in the art can vary or modify according to different situations. For example, aperture stops of the aperture may be installed in front of a convex side of the optical lens near the object. The optical lens 206 can be a bi-convex lens capable of spotlighting (a least one side among a convex side of the Bi-Convex lens nearest the object and the convex side of the Bi-Convex lens nearest a formed image is aspheric) or a concavo-convex lens (a least one side among a concavo side of the concavo-convex lens nearest the object and a convex side of the concavo-convex lens nearest a formed image is aspheric). The material can be blue glass or a plastic capable of receiving infrared light and superiorly conforms to following situation:

0.4f≦d≦0.9f;

0.2≦|(R1+R2)/(R1−R2)|≦0.7; and

20≦Abbe≦90;

wherein f is effective focal length of the camera lens, d is a center thickness of the optical lens 206, R1 is curvature radius of a convex side of the optical lens nearest the object, R2 is curvature radius of a convex side of the optical lens nearest a formed image, and Abbe is the Abbe-Apertometer of the optical lens.

Briefly speaking, choosing the appropriate optical lens, which fits to the above requirements can achieve the function of filtering infrared light and optical lens. Therefore, the present invention can filter infrared light for maintaining imaging quality without extra infrared light filtering elements or any sheet glass capable of receiving infrared light. Therefore, the present invention can lower the fabrication complexity and productions cost and maintain optical imaging quality at the same time.

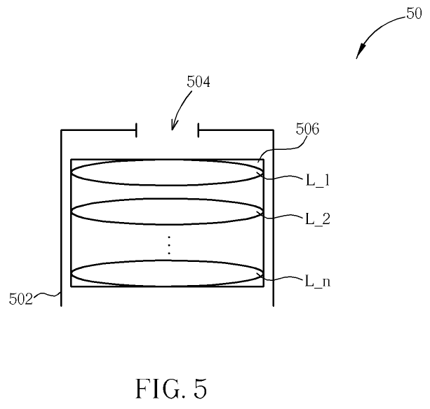

The camera lens 20 with single lens shown on FIG. 2 comprises a single optical lens. Beside that, the present invention further provides a camera lens with a plurality of optical lenses for lowering fabrication complexity and productions cost and maintaining optical imaging quality. Please refer to FIG. 5. FIG. 5 illustrates a schematic diagram of a camera lens 50 with multiple lenses of the present invention. The camera lens 50 with multiple lenses comprises a barrel 502, an aperture 504, and the optical lens L_1-L_n. The barrel 502 is utilized for protecting the plurality of optical lens 506 from damage or accumulating dust. The aperture 504 is utilized for adjusting and controlling the amount of light input into the barrel. Parts or the entire lens in the optical lens L_1-L_n are made by a material capable of filtering infrared rays for filtering infrared light and performing optical lensing.

Therefore, the optical lens L_1-L_n can filter out the infrared light and image the object on an image sensor or a negative of a photo (not shown on the FIG. 5). In other words, the camera lens 50 with multiple lenses L_1-L_n can filter the infrared light without extra infrared light filtering elements or the sheet glass capable of receiving the infrared light.

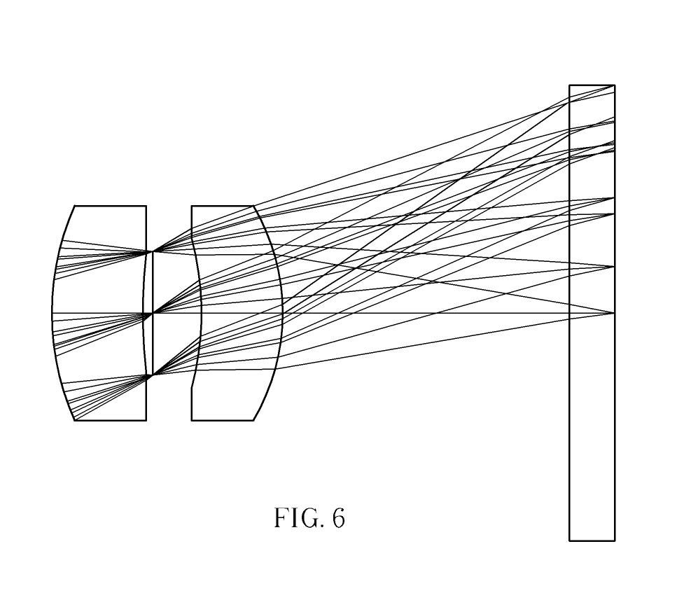

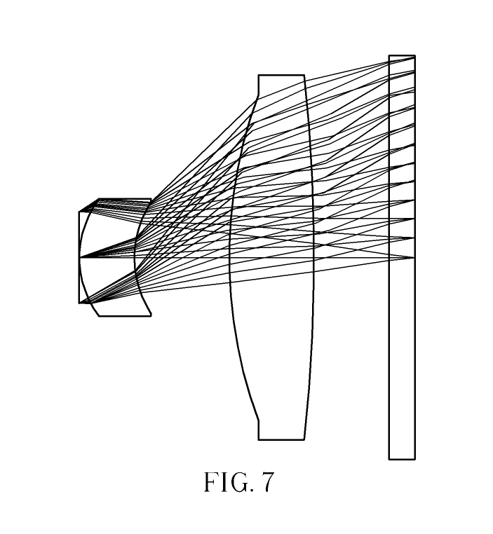

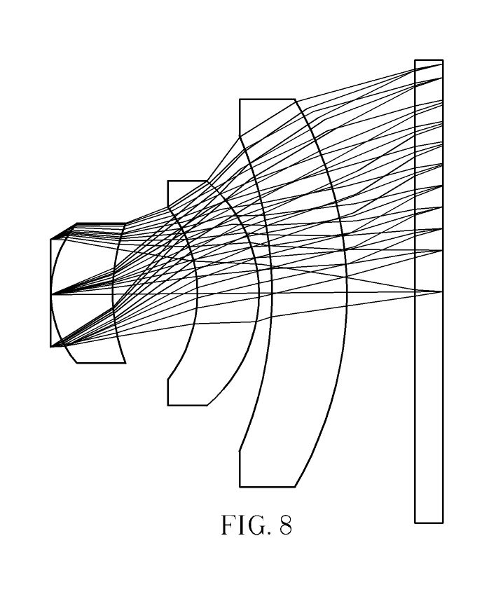

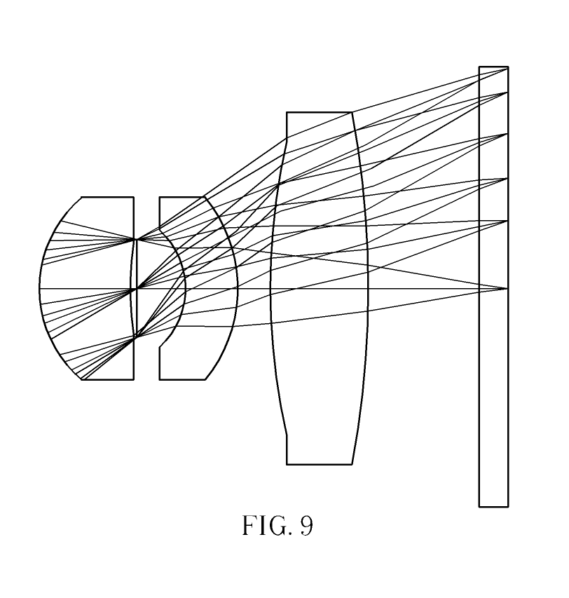

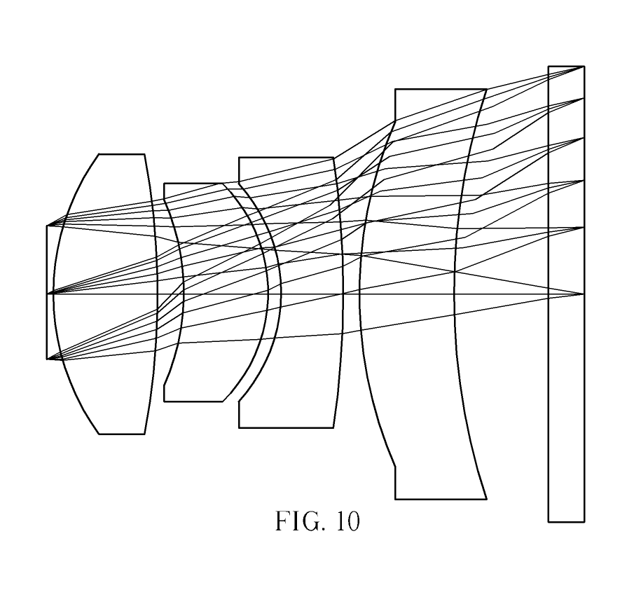

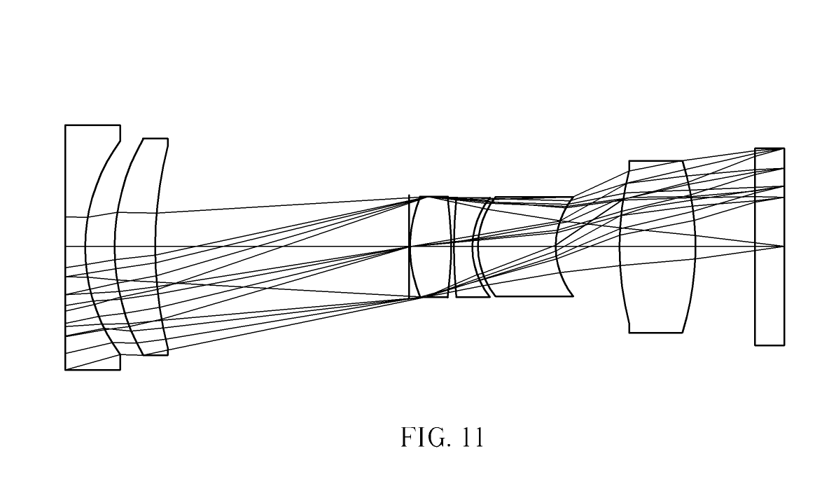

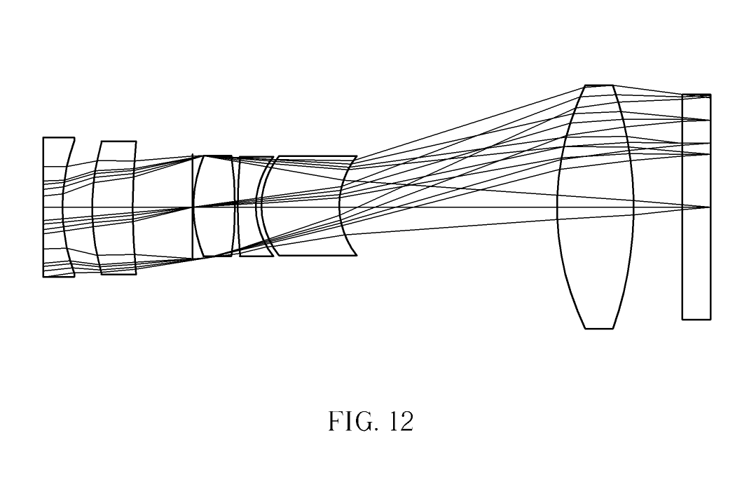

Note that, FIG. 5 illustrates a schematic diagram of a camera lens 50 with multiple lenses L_1-L_n according to an embodiment of the present invention. Those skilled in the art can very or modify according to different situations. For example, the aperture is not always in the front. The aperture can be put in any location between the lenses L_1-L_n. The numbers, materials, and permutation ways of the optical lenses L_{—}1-L_n according to different imaging quality, focal distance, the size of the aperture 504 in the optical lens 50 may also be different. For example, the number of the optical lenses L_1-L_n can be reduced to two pieces, and one or two lenses of the two optical lenses are materials capable of receiving infrared light such as blue glass or a plastic when the camera lens 50 with multiple lenses L_1-L_n is utilized for low-level image reception device. The imaging principles are shown as FIG. 6 or FIG. 7. In the same way, the number of the optical lenses L_1-L_n can be three pieces, and at least one of the three optical lenses L_1-L_n is the material capable of receiving infrared light such as blue glass and/or a plastic when the camera lens 50 with multiple lenses L_1-L_n is utilized for the higher level image reception device. The imaging principles are shown as FIG. 8 and FIG. 9. Furthermore, the number of the optical lenses L_1-L_n can be four pieces, and at least one of the four optical lenses is the material capable of receiving infrared light such as blue glass or a plastic when the camera lens 50 with multiple lenses L_1-L_n is utilized for the highest level image reception device. The imaging principle is shown as FIG. 10. Beside that, the camera lens 50 with multiple lenses L_1-L_n is also utilized for realizing zoom lenses for providing higher image quality. Taking the optical lenses L_1-L_n with five lenses as example, the zoom imaging principles are shown in FIG. 11 and FIG. 12. At least one of the five optical lenses is using the material capable of receiving infrared light such as blue glass and/or plastic.

From above-mentioned, at least one optical lens of the optical lenses L_1-L_n is using the material capable of receiving infrared light such as blue glass and/or plastic such that the camera lens 50 with multiple lenses L_1-L_n can achieve the function of filtering infrared rays and optical lensing through the optical lens L_1-L_n. Therefore, the camera lens 50 with multiple lenses L_1-L_n can filter the infrared light for maintaining imaging quality without adding extra material of infrared rays filtering elements or sheet glass capable of receiving infrared light so as to filter the infrared light for maintaining imaging quality. Therefore, the camera lens 50 with multiple lenses L_1˜L_n can lower the fabrication complexity and cost production and maintain optical imaging quality at the same time.

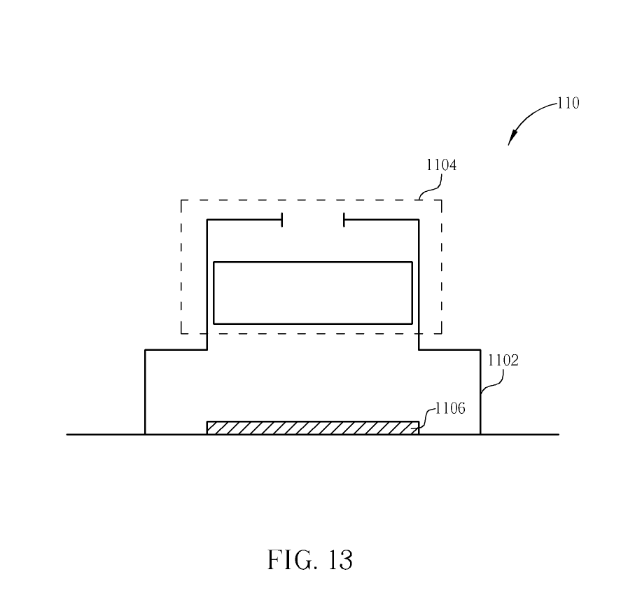

About applications of the camera lens 20 with single lens shown in FIG. 2 and the camera lens 50 with multiple lenses shown in FIG. 5, please refer to FIG. 13. FIG. 13 illustrates a schematic diagram of an image reception device 110 of the present invention. The image reception device 110 can lower the fabrication complexity and cost production and maintain the optical imaging quality. The image reception device 110 comprises a housing 1102 comprising a front opening; a camera lens 1104 installed on the front opening; and an image sensor 1106 installed in a location corresponding to the camera lens 1104 inside the housing 1102 for transforming the input light through the camera lens 1104 into current signal. The camera lens 1104 can be the camera lens 20 with single lens shown in FIG. 2 or the camera lens 50 with multiple lenses shown in FIG. 5. The optical lens can be made by material capable of receiving infrared light for filtering the infrared light and performing optical imaging.

Therefore, the optical lens of the camera lens 1104 can filter out infrared light and image the object on the backside image sensor 1106 by the image reception device 110 when light transmits into the camera lens 1104 through the aperture. In other words, the image reception device 110 can filter the infrared light without extra adding infrared rays filtering element and/or sheet glass capable of receiving infrared light.

In a conclusion, the present invention is using a material capable of receiving infrared light such as plastic, glass, or other materials for making the optical lens utilized for imaging. Therefore, the present invention can filter infrared light and reduce fabrication steps for quantity production without extra adding infrared rays filtering element or sheet glass capable of receiving infrared light.

Those skilled in the art will readily observe that numerous modifications and alterations of the device and method may be made while retaining the teachings of the invention.

What is claimed is:

1. A camera lens capable of filtering infrared light comprising:
a barrel;
an aperture installed on the barrel for controlling the amount of input light; and
an optical lens installed inside the barrel for filtering the infrared light and performing optical lens of an object.

2. The camera lens of claim 1, wherein aperture stops of the aperture are installed in front of a convex side of the optical lens nearest the object.

3. The camera lens of claim 1, wherein the optical lens conforms to:
0.4f≦d≦0.9f;
0.2≦|(R1+R2)/(R1−R2)|≦0.7; and
20≦Abbe≦90;
wherein f is effective focal length of the camera lens, d is a center thickness of the optical lens, R1 is curvature radius of a convex side of the optical lens nearest the object, R2 is curvature radius of a convex side of the optical lens nearest a formed image, and Abbe is the Abbe-Apertometer of the optical lens.

4. The camera lens of claim 1, wherein the optical lens is a Bi-Convex lens.

5. The camera lens of claim 4, wherein a least one side among a convex side of the Bi-Convex lens nearest the object and the convex side of the Bi-Convex lens nearest a formed image is aspheric.

6. The camera lens of claim 1, wherein the optical lens is a concavo-convex lens.

7. The camera lens of claim 6, wherein a least one side among a concavo side of the concavo-convex lens nearest the object and a convex side of the concavo-convex lens nearest a formed image is aspheric.

8. The camera lens of claim 1, wherein the optical lens is made by a material capable of filtering infrared light.

9. The camera lens of claim 8, wherein the material is glass.

10. The camera lens of claim 8, wherein the material is plastic.

11. An image acquisition gateway capable of reducing production cost comprising:
a housing comprising a front opening;
a camera lens installed on the front opening comprising:
a barrel;
an aperture installed on the barrel for controlling the amount of input light; and
an optical lens assembly installed inside the barrel for filtering infrared light and performing optical lens of an object; and
an image sensor installed in a location corresponding to the camera lens inside the housing for transforming the input light through the camera lens into current signal.

12. The image acquisition gateway of claim 11, wherein the optical lens assembly comprises an optical lens.

13. The image acquisition gateway of claim 12, wherein the optical lens conforming to:
0.4f≦d≦0.9f;
0.2≦|(R1+R2)/(R1−R2)|≦0.7; and
20≦Abbe≦90;
wherein f is effective focal length of the camera lens, d is a center thickness of the optical lens, R1 is curvature radius of a convex side of the optical lens nearest the object, R2 is curvature radius of a convex side of the optical lens nearest the image sensor, and Abbe is the Abbe-Apertometer of the optical lens.

14. The image acquisition gateway of claim 12, wherein the optical lens is a Bi-Convex lens.

15. The image acquisition gateway of claim 14, wherein a least one side among a convex side of the Bi-Convex lens nearest the object and a convex side of the Bi-Convex lens nearest the image sensor is aspheric.

16. The image acquisition gateway of claim 12, wherein the optical lens is a concavo-convex lens.

17. The image acquisition gateway of claim 16, wherein a least one side among a concavo side of the concavo-convex lens nearest the object and a convex side of the concavo-convex lens nearest the image sensor is aspheric.

18. The image acquisition gateway of claim 12, wherein the optical lens is made by a material capable of filtering infrared.

19. The image acquisition gateway of claim 18, wherein the material is glass.

20. The image acquisition gateway of claim 18, wherein the material is plastic.

21. The image acquisition gateway of claim 11, wherein the optical lens assembly comprises a plurality of optical lens.

22. The image acquisition gateway of claim 21, wherein one optical lens of the plurality of optical lens is made by a material capable of filtering the infrared light.

23. The image acquisition gateway of claim 22, wherein the material is glass.

24. The image acquisition gateway of claim 22, wherein the material is plastic.

25. The image acquisition gateway of claim 21, wherein each of the plurality of the optical lens is made by a material capable of filtering the infrared light.
